(19) United States
(12) Patent Application Publication
(10) Pub. No.: US 2014/0316896 A1
(43) Pub. Date: Oct. 23, 2014

(54) DECISIONING SYSTEM FOR EVALUATING AND DELIVERING OPTIMIZATION, LAYOUT, AND OTHER STORE INSIGHTS FROM LOCATION DATA

(71) Applicant: Erik McMillan, Austin, TX (US)

(72) Inventor: Erik McMillan, Austin, TX (US)

(21) Appl. No.: 14/171,544

(22) Filed: Feb. 3, 2014

Related U.S. Application Data
(60) Provisional application No. 61/760,018, filed on Feb. 1, 2013.

(51) Int. Cl. G06Q 30/02

(52) U.S. Cl. CPC G06Q 30/0261
USPC 705/14.58

(57) ABSTRACT

The present disclosure provides a system, method and computer readable medium that enables the delivery of data to retail stores and their affiliates. In addition, the present disclosure augments existing data gathering solutions. One embodiment of the present disclosure is capable of tracking client movement within a store, and presenting the client with targeted advertisements.

### CROSS-REFERENCE TO RELATED APPLICATIONS

This applications claims priority to U.S. Provisional Patent Application Ser. No. 61/760,018]], filed Feb. 2, 2013, which is hereby incorporated by reference in its entirety.

### BACKGROUND OF THE INVENTION

Other solutions to tracking customers in a brick-and-mortar retail store are expensive, limited in their data gathering abilities, and only some customers can be tracked. The current invention delivers data that retail stores have a need for and are asking for. In addition, the current invention can augment existing data gathering solutions adding more value to the data already being gathered. Current solutions are built on RFID, video capture, infrared image capture which provide limited data gathering capabilities.

### BRIEF SUMMARY OF THE INVENTION

Customer location is tracked in a number of ways depending on if a customer is using a mobile device and how the mobile device is configured. If a customer does not have a mobile device, then the customer may be tracked using a mobile beacon embedded in a shopping cart. One scenario with the least interaction is where a customer without a mobile device or with a mobile device that does not have a compatible Bluetooth radio or with a mobile device with the Bluetooth radio turned off. A second scenario with moderate interaction is where a customer with a mobile device and a Bluetooth radio turned on. A third scenerio with the most interaction is where a customer with a mobile device has a Bluetooth radio turned on, and an app running on their mobile device.

Two uses for the data are for an operational manager of a retail store and second for a store manager. For the operational manager, the real-time data from the system is of great use. For example, the operational manager may want to ensure that employees are where the customers are. The operational manager may use the real-time data of the locations of the employees and customers to ensure that the employees are where they need to be. If an employee is not in the right location, the operational manager may send the employee a message indicating where the employee needs to go to help a customer.

For the store manager, the processed data from the system is of great use. For example, the store manager may want to determine long-term trends in how customers are behaving with a store. This information is useful in determining how to layout the store, where to place special promotional products, or where to place advertisements. If a store manager knows where customers most often walk through a store then an advertisement can be placed in a location to target the most number of customers possible.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 is a flow diagram of a decisioning system according to one embodiment of the present invention.

FIG. 2 is a flow diagram of a scenario for sending data to a server.

FIG. 3 is a flow diagram of a scenario for sending data to a mobile device.

FIG. 4 depicts an illustrative retail setting for deployment of a decisioning system wherein two static beacons are utilized.

FIG. 5 depicts an illustrative retail setting for deployment of a decisioning system wherein four static beacons are utilized for department-level customer tracking.

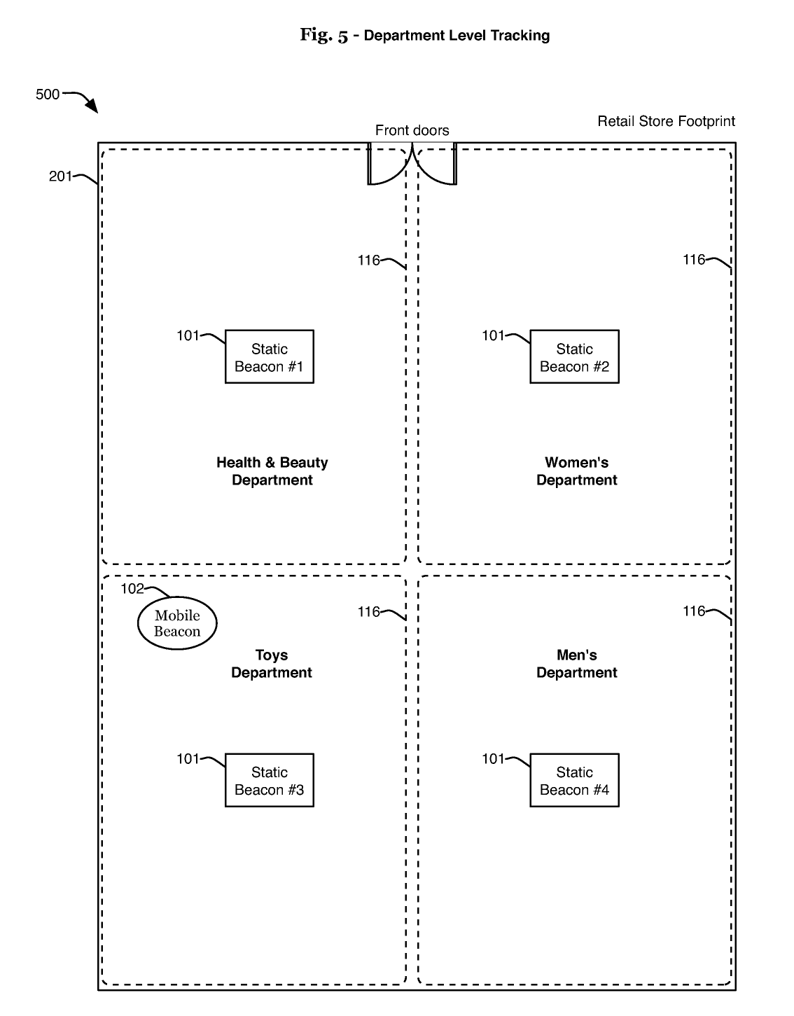

FIG. 6 depicts an illustrative retail setting for deployment of a decisioning system wherein three static beacons are utilized for aisle-level customer tracking.

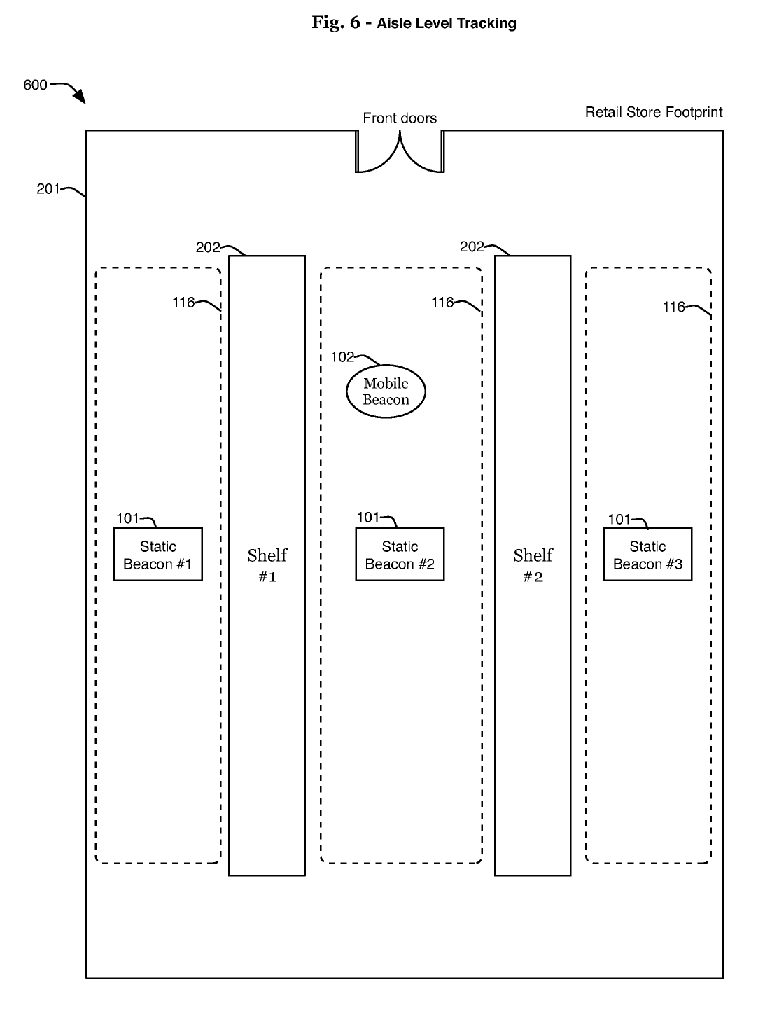

FIG. 7 depicts an illustrative retail setting for deployment of a decisioning system wherein one static beacons is utilized for end cap customer tracking.

FIG. 8 depicts an illustrative retail setting for deployment of a decisioning system wherein a multitude of static beacons are utilized for product-level customer tracking.

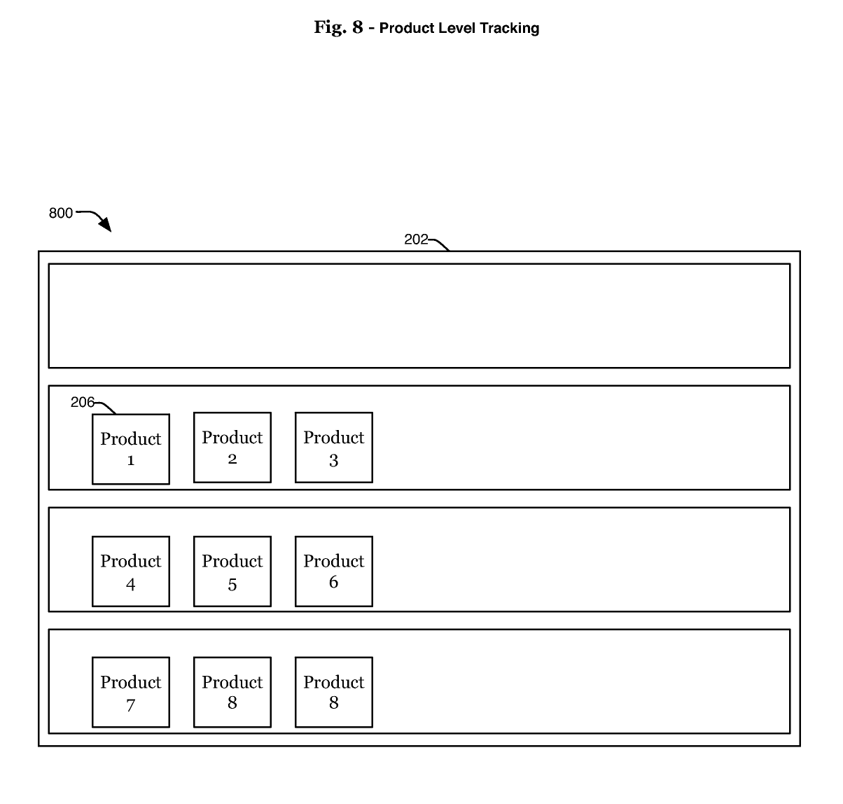

FIG. 9 depicts some of the processes the decisioning system performs within the various components.

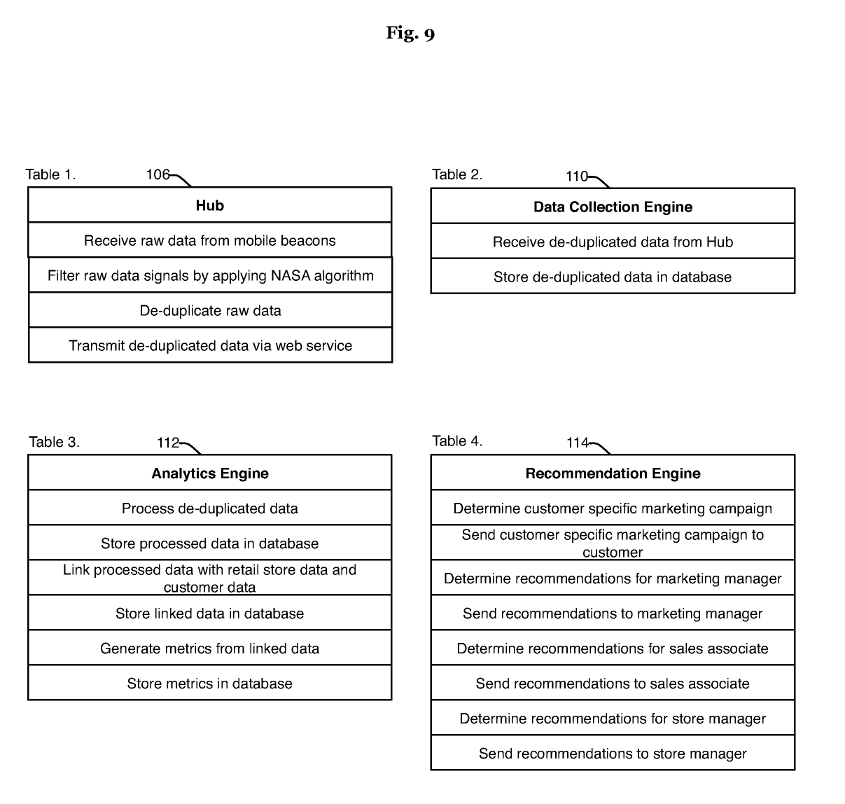

### DETAILED DESCRIPTION OF ILLUSTRATIVE EMBODIMENTS

Reference now should be made to the drawings, in which the same reference numbers are used throughout the different figures to designate the same components.

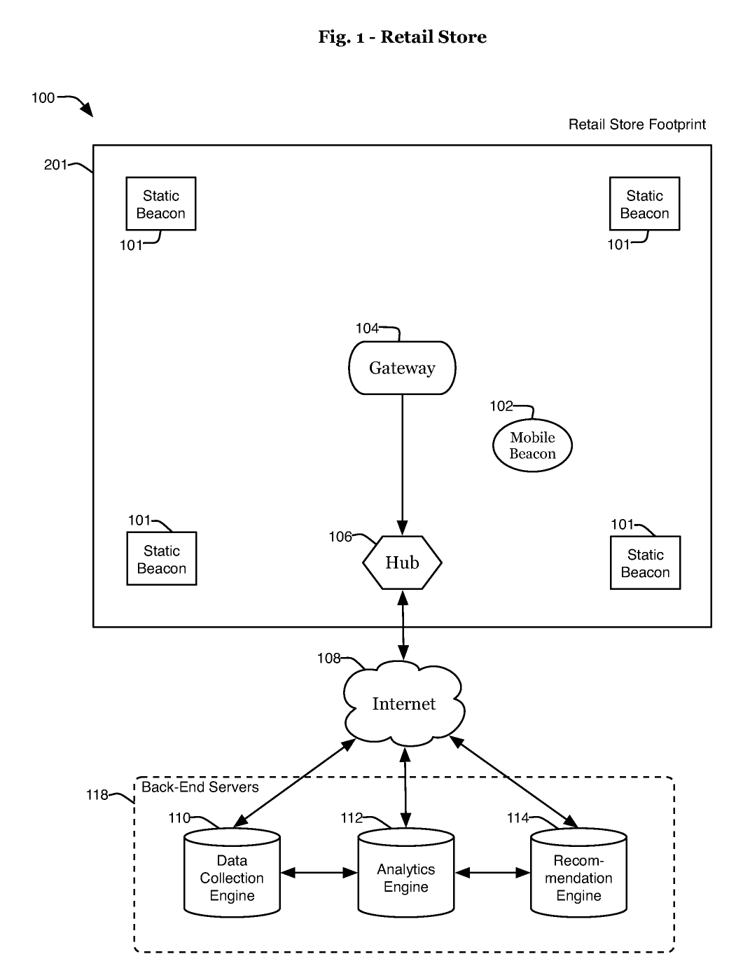

FIG. 1 depicts a decisioning system 100 according to one embodiment of the present invention. As shown, a static beacon 101 is situated in the four corners of a retail store 201 which is a non-movable object comprising an embedded Low Energy Bluetooth radio, processor, and memory. The static beacon is installed in a location and remains there until installed in another location. The static beacon is non-movable in the sense that it is designed to remain in the same location for a period of time such as a day, a week, or a year. A static beacon advertises data while a mobile beacon 102 observes data.

A mobile beacon 102 is situated in the retail store 201 and moves freely around the store. A mobile beacon is a movable object comprising an embedded Low Energy Bluetooth radio. An example would be a shopping cart with a Low Energy Bluetooth radio embedded within. Another example of a mobile beacon is a mobile device with a Low Energy Bluetooth radio built-in such as an Apple iPhone 5 or Apple iPad 4th generation.

A gateway 104 is situated in the center of the retail store 201. A gateway observes data sent from a mobile beacon then converts the Low Energy Bluetooth data into Wifi data and passes the data to the hub. In this embodiment the gateway and hub are separate devices. In other embodiments, the gateway and hub may be combined in one device such as a computer.

In this embodiment, a hub 106 is situated in the back of the store such as in a back office or in a storage area. A hub may be located wherever is convenient for connecting a hub to a power supply and to an Internet connection. The hub 106 transmits data via web service over the Internet to a data collection engine 110. A data collection engine 110 is a computer server which comprises a database wherein data received from a hub is stored. A back-end server configuration may comprise a data collection engine 110, an analytics engine 112, and a recommendation engine 114 within one computer server or may each be on separate computer servers.

An analytics engine 112 is a computer server which accesses the data within a data collection engine for processing and analyzing. A recommendation engine 114 is a computer server which accesses the data within a analytics engine for further processing and analyzing.

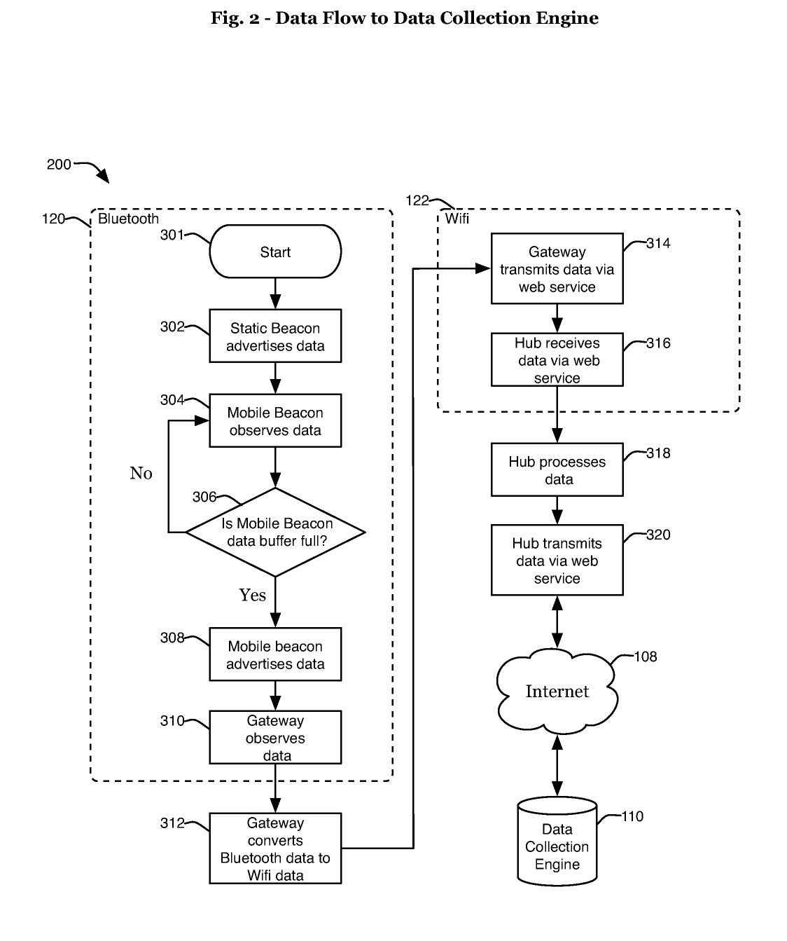

FIG. 2 is a flow diagram 200 of a scenario for sending data to a data collection engine 110. In this embodiment, this scenario starts 301 when a customer enters a retail store with mobile device running an application that utilizes the Low Energy Bluetooth radio in the mobile device. A static beacon advertises data 302 via a Low Energy Bluetooth radio where the data comprises a beacon ID, RSSI, battery level, and device state info. A mobile beacon observes data 304 from a static beacon and saves the data into a memory buffer. The mobile beacon continues to observe data until the memory buffer is full 306 at which time the mobile beacon advertises the data 308 in the memory buffer. A gateway observes data 310 from a mobile beacon then converts the data 312 from Low Energy Bluetooth data to Wifi data. Then the gateway transmits the data via web service 314 to a hub which receives the data via web service 316. The data may be transmitted from the gateway to the hub in various ways including wirelessly via Wifi, wired via ethernet, or any other means for transmitting data via web service. A hub processes the data 318 by performing several functions comprising de-duplication of data. The scenario ends when the hub transmits the data via web service 320 via the internet to a data collection engine 110.

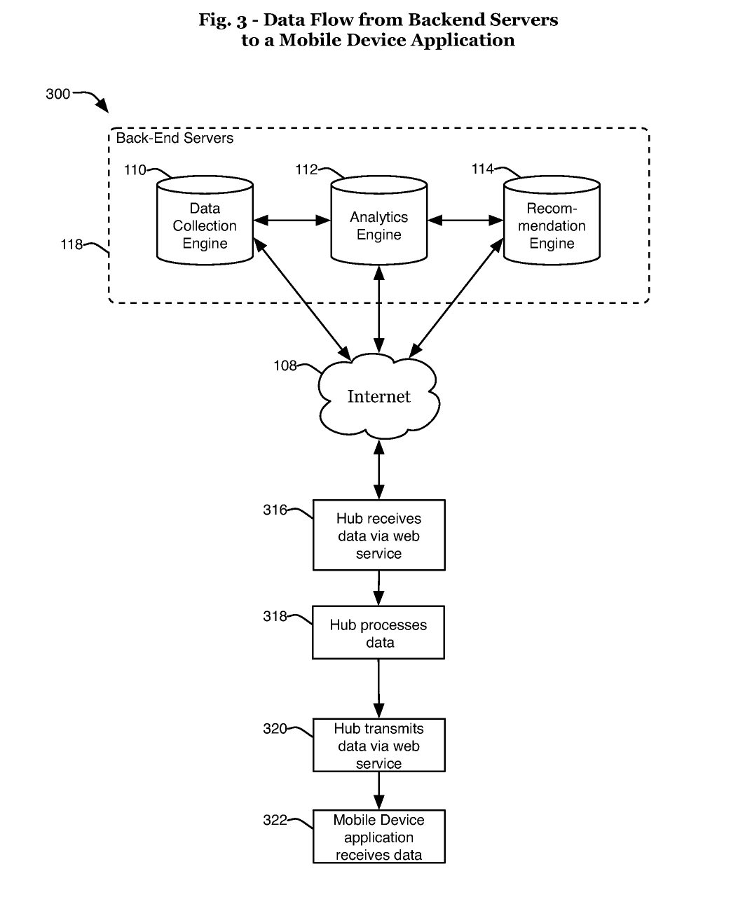

FIG. 3 is a flow diagram 300 of a scenario for sending data to a mobile device. In this embodiment, this scenario starts when an analytics engine 112 or recommendation engine 114 has determined a person with a mobile device should have data sent to them. A person could be a customer in a retail store, a sales associate in a retail store, or an operations manager in a retail store. The analytics engine and recommendation engine make determinations based upon the data from the data collection engine then transmits the data via the internet 108 to a hub which receives data via web service 316. The hub then processes the data 318 and transmits the data via web service 320 to the appropriate mobile device application. The scenario ends when a mobile device application receives the data 322.

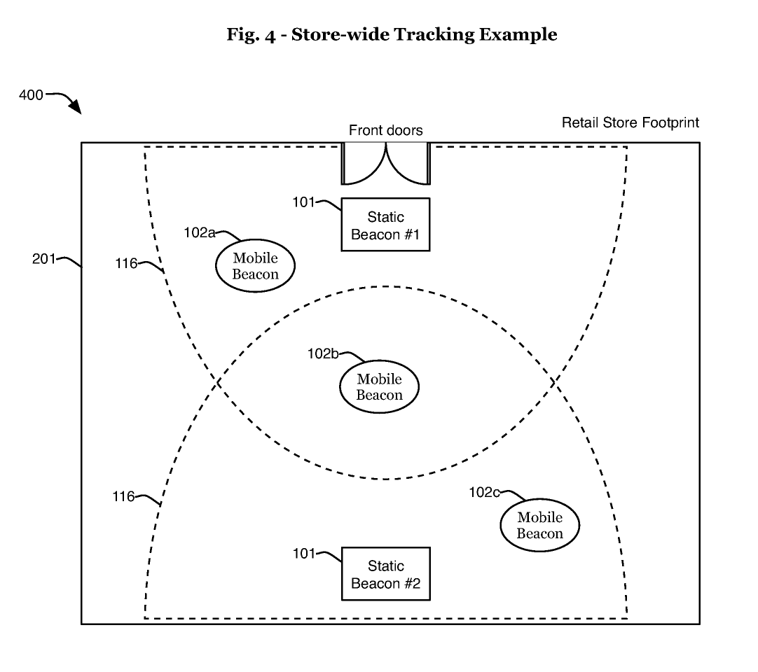

FIG. 4 depicts an illustrative retail setting 400 for deployment of a decisioning system wherein two static beacons are utilized. In this configuration, one static beacon 101 is located near the entrance, “Static Beacon #1.” Another static beacon 101 is located near the back of the store, “Static Beacon #2.” A gateway is located in the center of the store (not shown). A hub is located in the back office of the store (not shown). A mobile beacon 102 is embedded in a shopping cart.

A customer enters the store and begins moving the shopping cart with a mobile beacon 102a embedded. Static Beacon #1 and Static Beacon #2 are in broadcast mode advertising data. The mobile beacon 102a is in observer mode and receives the data packets from Static Beacon #1 only since the mobile beacon 102a is located within the range of Static Beacon #1 116. The range of a static beacon 116 is depicted with a dashed line and merely illustrates the coverage area a particular static beacon is covering i.e. a distance from a static beacon that a mobile beacon may still be able to receive data from a static beacon. Once the mobile beacon 102a has received a certain amount of data, then the mobile beacon 102a changes to broadcast mode and sends the data out. Once the mobile beacon sends the data out, it changes back to observer mode and receives data packets. This process of receiving data and sending data is continuous. A gateway 104 receives this data, translates the data into a Wifi data packet, and sends the data via Wifi to a hub 106. The hub 106 receives the data, processes the data, and sends the data to the back-end servers 118.

The customer then moves the mobile beacon 102b to the center of the store where it receives data from Static Beacon #1 and Static Beacon #2 since the mobile beacon 102b is within the range of both static beacons 116. Once the mobile beacon 102b has received a certain amount of data, then the mobile beacon 102b changes to broadcast mode and sends the data out. A gateway 104 receives this data, translates the data into a Wifi data packet, and sends the data via Wifi to a hub 106. The hub 106 receives the data, processes the data, and sends the data to the back-end servers 118.

The customer then moves the mobile beacon 102c near “Static Beacon #2. The mobile beacon 102c receives the data packets from Static Beacon #2 only since the mobile beacon 102c is located within the range of Static Beacon #2 116.

The manager ma. view the data collected by the system over a period of time. The manager may then determine many things such as how many customers entered the store, how long did customers stay in the store, how long did customers stay in the back of the store.

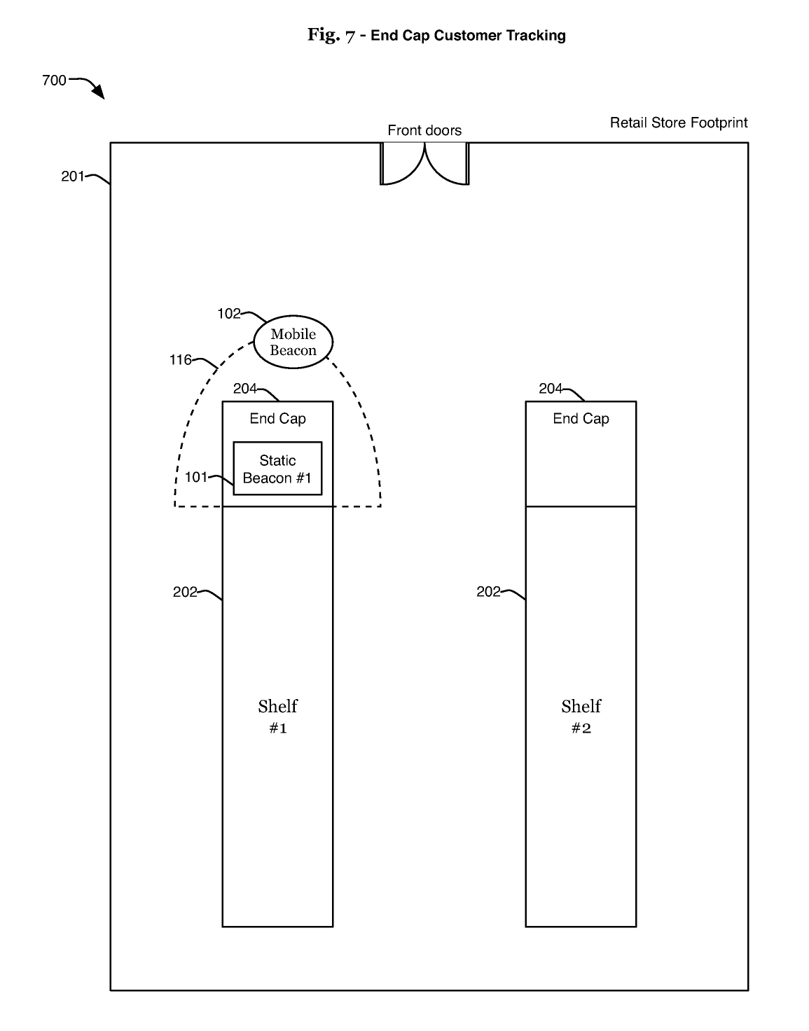

FIG. 7 depicts another configuration of the system comprising one static beacon and one mobile beacon. The static beacon is located inside a retail store and affixed to the endcap of an aisle behind an advertisement display. The mobile beacon is a customer's holding a mobile device with a Low Energy Bluetooth radio. The customer approaches the static beacon. The static beacon receives Low Energy Bluetooth radio signals from the mobile beacon. The static beacon then processes the radio signals from the mobile beacon to determine if the customer is close enough to begin an interaction with the customer. The static beacon determines the nearness of the mobile beacon by processing the radio signal strength data. Once the static beacon has determined the mobile beacon is close, then the static beacon send a message to the mobile beacon. The message may be a coupon, a request for an email address to receive coupons in the future from the retail store, or a URL to a webpage to learn more about a product the customer may want.

What is claimed is:

1. A system, method, apparatus and non-transient computer readable medium as disclosed above.
